(19) United States
(12) Patent Application Publication
(10) Pub. No.: US 2026/0067333 A1
(43) Pub. Date: Mar. 5, 2026

(54) DECEPTION AS A SERVICE (DAAS) SYSTEM WITH LARGE SCALE DEPLOYMENT OF TEMPLATE-BASED DECOYS

(71) Applicant: Fortinet, Inc., Sunnyvale, CA (US)

(72) Inventors: Jun Jiang, Vancouver (CA); Hongquan Mi, Burnaby (CA); Moshe Ben Simon, Atlit (IL)

(73) Assignee: Fortinet, Inc., Sunnyvale, CA (US)

(21) Appl. No.: 18/823,902

(22) Filed: Sep. 4, 2024

(51) Int. Cl. H04L 9/40

(52) U.S. Cl. CPC H04L 63/1491

(57) ABSTRACT

A deception as a service (DaaS) system configures a decoy to generate a decoy instance, and projects the decoy instance into a user network. The DaaS system receives, by the decoy in the deception system, from an edge point in the user network, an attack request on the decoy instance by an attacker, generates an attack response by the decoy based at least in part on the attack request; and sends the attack response to the attacker. The attack response may include erroneous information, such as a lure file or lure credentials.

### BACKGROUND

Various embodiments of the present disclosure generally relate to computer networks, network security and computing systems. In particular, some embodiments relate to providing decoys based on decoy templates as a service in a computing system.

Deception technology has been playing a crucial role in the cybersecurity industry. By deploying a variety of fake assets that are shown as real assets in a computer network, deception technology may attract attackers into traps to obtain misleading information, ultimately protecting valuable real assets and critical services. In addition, the information on incidents and detection, such as malicious actions and tactics, gathered from attackers helps organizations strengthen their protection and defense systems.

However, attackers have learned skills over time to try to bypass the deception system by identifying the traps. To keep traps hard-to-detect, protective and high fidelity, deception systems have been developed with a complex approach including complicated design, configuration and deployment phases. In one approach, a high-interaction decoy, which mimics services, graphical user interfaces (GUIs), and responses as part of a legitimate operating system (OS), has been increasingly applied in recent deception technology, especially in the technical areas of Operation Technology (OT), Information Technology (IT), and Internet of Things (IoT) devices. In another approach, a low-interaction decoy, also called a honeypot, is limited in simulating minimal services, open ports or specific vulnerabilities without OS or full-service support. The existing tactics by an attacker for honeypot detection weaken the capability of the threat defenses and security protection provided by the deception system. Furthermore, low-interaction decoys are currently providing low performance, high false positives and limited attribution and threat intelligence results.

High-interaction deceptions face challenges as well. Traditionally, high-interaction deceptions are executed in a deception physical or virtual appliance that is set up in the local network. This appliance is used as the deception host to manage and operate decoys, as well as to provide lure data and tracing attack sessions. Thus, the initial costs of this local network-based approach are high in terms of hardware platform requirements. Also, deploying a high-interaction deception system into the user's local network to achieve optional performance requires highly skilled information technology (IT) professionals with deep knowledge of deception technology, and network and security expertise. Configuration for the high-interaction decoys is a complicated process that combines a variety of considerations such as device identification setting, protocol configuration, service setting, etc. Without appropriate configuration, it is feasible for decoys to be identified and compromised by a skilled attacker, which causes substantial remedial effort and investment loss for the organization. Furthermore, regular maintenance is required as well, which causes a long-term burden for the organizations in terms of significant human resources and labor costs.

### SUMMARY

Systems and methods are described for providing and managing deception technology in the context of computer network and cloud computing. The present disclosure describes a high fidelity, high-interaction operating system (OS)-based deception service with decoy template-based deployment on a cloud server. The deception is delivered as a service, called Deception-as-a-Service (DaaS) in the present disclosure. As described herein, one or more decoys may be deployed on a cloud service provider's defined cloud service platform and projected to a user's defined network. All the projected decoys are deployed locally (e.g., in the user's network) and support high-fidelity interaction and communication, and the decoys are centrally managed and maintained by the cloud service provider (CSP). The present disclosure describes the system and methods for utilizing decoy template-based deployment management to project full OS-based, high-interaction decoys to on premise networks of users. Various types of full OS-based, high-interaction decoys in the present disclosure may be provided for a variety of technology areas such as OT, IT, IoT, etc.

The present disclosure includes the capability of delivering OS-based, high-interaction as a service targeting a large variety of user groups by applying decoy template-based decoys with different configurations for different usages. The DaaS system creates decoy instances and dynamically installs lure data (such as lure users, lure documents, lure fingerprints, lure identifications, lure tokens, and so on). The present disclosure includes a cost-effective approach that manages and presents large numbers of virtualized highly interactive decoys to very large numbers of end users as a cloud-based service while consuming cost-effective resources and giving customization capability and flexibility to those users.

In some embodiments, the DaaS system described herein automatically customizes, deploys, and manages decoy assets, and provides an intuitive way to configure and monitor these deception assets with wizard-based deployment. The DaaS system creates code images based on pre-defined default templates, as well as custom templates. These code images span several OS types, including but not limited to Windows Desktop/Server, Linux, virtual private network (VPN), IoT, and OT, etc. Techniques are provided and presented to a user's premise network via an edge point from a cloud server. The edge point runs as an agent in the user's network and may be set up in the format of virtual appliance, hardware appliance or application that projects the cloud running decoys to the premise network with a specific network configuration to appear as local assets and/or services in the premise network. When an attack or malicious action occurs, the requests from the attacker result in redirecting all traffic to the targeted asset from the edge point to the DaaS system in the cloud server. Furthermore, the DaaS system mimics the services and assets of the user's network and then generates a response based on decoy templates or customized configurations to send the traffic back to the premise network via the edge point. Therefore, the seamless interaction with the decoy in the user's network with the DaaS system running in the cloud server provides the same user experience as with actual, legitimate local assets and services, thereby deceiving an attacker, which achieves protection for the assets and services in the premise network.

In some embodiments, the DaaS system provides a capability to achieve mass virtualization by managing decoys running in the centrally managed cloud server to get “sharing” access over defined user groups. These decoys are called public decoys in this disclosure.

In some embodiments, the DaaS system provides a capability to create multiple identical clones for the public decoy (also called decoy instances herein) owned by a cloud server or across multiple cloud servers managed by the cloud service provider (CSP). The DaaS system may also provide load balancing and performance optimization services.

In some embodiments, the DaaS system provides a capability to support user custom-defined decoys that exclusively project to the user's defined network. These decoys are called private custom decoys herein.

In some embodiments, the DaaS system provides a capability to optimize decoy placement by performing asset (both active and passive) discovery running on the edge point. The edge point discovers the asset inventory in the user's network and sends device identification information of one or more assets to the DaaS system, thus automatically starting the decoy projection process and presenting the decoy running on the cloud server to the premise network as a decoy instance with minimal human interaction at the user's network.

In some embodiments, the DaaS system may be integrated with third-party security software and/or hardware tools (such as Fortinet Security Fabric (e.g., FortiGate, FortiEDR, and FortiNAC, as well as with FortiSIEM, FortiSoar, and FortiAnalyzer, commercially available from Fortinet, Inc.), thereby providing a unified, automated threat mitigation service, and delivering comprehensive visibility and enriched threat intelligence data for fast analysis and accelerated responses. In addition, the DaaS system provides a capability to remotely and automatically quarantine/manual block/manual unblock malicious devices or actions as needed by integrating with third-party application programming interfaces (APIs) and premise devices. The edge point is running as an agent for the DaaS system, dispatching integration settings and quarantine tasks received from the DaaS system running in the cloud server, and launches the fabric integration process accordingly to handle the deception tasks with third party applications.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a computing environment for a Deception as a Service (DaaS) system according to an embodiment of the present disclosure.

FIG. 2 illustrates a DaaS system architecture according to an embodiment of the present disclosure.

FIG. 3 illustrates DaaS system processing according to an embodiment of the present disclosure.

FIG. 4 illustrates deployment of template-based decoy instances according to an embodiment of the present disclosure.

FIG. 5 illustrates initialization processing for a decoy template according to an embodiment of the present disclosure.

FIG. 6 illustrates initialization processing for a decoy according to an embodiment of the present disclosure.

FIG. 7 illustrates an example of traffic load balancing when multiple users request access to the same decoy according to an embodiment of the present disclosure.

FIG. 8 illustrates an example of the use of public decoys and a private custom decoy by different users according to an embodiment of the present disclosure.

FIG. 9 illustrates an example of different projections of decoy instances based on different configurations from the same public decoy according to an embodiment of the present disclosure.

FIG. 10 illustrates processing of decoy template and decoy management according to an embodiment of the present disclosure.

FIG. 11 illustrates processing of a new decoy template according to an embodiment of the present disclosure.

FIG. 12 illustrates processing for launching a decoy instance according to an embodiment of the present disclosure.

FIG. 13 illustrates processing for launching a private custom decoy instance according to an embodiment of the present disclosure.

FIG. 14 illustrates processing and communication between a DaaS system and a DaaS edge point according to an embodiment of the present disclosure.

FIG. 15 illustrates an example of asset discovery and deployment of decoy instances according to an embodiment of the present disclosure.

FIG. 16 illustrates an example of traffic management for multiple deployed decoy instances and user networks according to an example of the present disclosure.

FIG. 17 illustrates an example of a user interface for a deployment wizard to configure a decoy according to an example of the present disclosure.

FIG. 18 illustrates an example of a user interface to select a network for deployment of a decoy according to an example of the present disclosure.

FIG. 19 illustrates an example of user interface to display a summary of the decoy configuration according to an example of the present disclosure.

FIG. 20 illustrates an example computing system in which or with which embodiments of the present disclosure may be utilized.

### DETAILED DESCRIPTION

The ‘as-a-service’ models, such as Software as a Service (SaaS), Infrastructure as a Service (IaaS) and Platform as a Service (PaaS), have been growing rapidly and are relatively mature in the technology market. The provided services are running in the cloud (e.g., on a cloud server provided by a CSP) and delivered over the Internet, instead of being installed and hosted in the premise network. This enables users to access the services without maintenance and management on their own and without making a big initial investment in the required software and hardware. Deception-as-a-Service (DaaS) is a concept wherein deceptive elements are created and hosted in the cloud server, then projected over the Internet (or other network) to the user's network with a valid local Internet Protocol (IP) address, medium access control (MAC) address, and open port to appear that the deception is deployed in the user's on-premises network. When the user's network is attacked, the request is captured, processed, and re-directed to the DaaS system via a private tunnel, and the response is generated and sent back to the attacker. The deceptive elements are pre-configured and centrally managed in the cloud by the DaaS system, thus the deception services provided by the DaaS system may be easily scaled up and down, and quickly set up without a complex deployment process by users.

The technology of the DaaS system described herein provides at least several advantages and technical improvements over existing computing systems. The DaaS disclosed in this application provides high-fidelity, high-interaction operating system (OS)-based decoys that closely mimic real systems, enhancing the realism and effectiveness of the deception. The DaaS supports mass virtualization by taking advantage of the template-based decoys and enables the deployment of large-scale decoy projections to user defined networks. A DaaS system means that all the real decoys are deployed and managed centrally on the cloud servers and then projected to the user local networks. The users save costs and efforts for system maintenance, complex decoy system setup, and deployment processₑₛ. The DaaS system automates the customization and deployment of decoys, _{and} with active and passive asset discovery, reducₑₛ the need for manual intervention and simplifᵢₑₛ the setup process while ensuring that decoys are deployed in the most effective locations. The DaaS system supports remote and automatic quarantine processes, manual blocking, and unblocking of malicious devices or actions, thereby enhancing the responsiveness to threats. The DaaS system provides both public decoys (shared across user groups) and private custom decoys (exclusive to a user's network), offering flexibility in deployment strategies while achieving maximum cost-effectiveness.

In the following description, numerous specific details are set forth to provide a thorough understanding of embodiments of the present disclosure. It will be apparent, however, to one skilled in the art that embodiments of the present disclosure may be practiced without some of these specific details. In other instances, well-known structures and devices are shown in block diagram form.

Brief definitions of terms used throughout this application are given below.

A “computer”, “computer system” or “computing system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” or a “computing system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

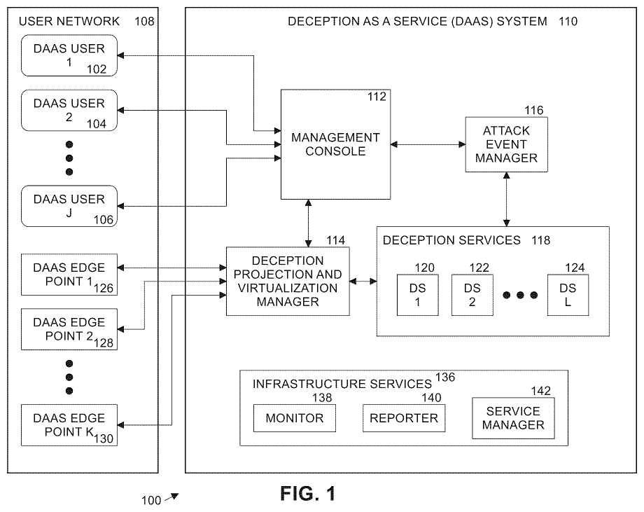

FIG. 1 illustrates a computing environment 100 for a Deception as a Service (DaaS) system 110 according to an embodiment of the present disclosure. In an embodiment, DaaS system 110 may be running on a cloud server (not shown in FIG. 1) provided by a CSP. DaaS system 110 may be communicatively coupled to a user network 108 over another network such as the Internet (not shown in FIG. 1). User network 108, and any computing systems and/or devices coupled to the user network, may be vulnerable to attack by an attacker over the Internet. User network 108 may include one or more users, such as DaaS user 1 102, DaaS user 2 104, . . . . DaaS user J 106, where J is a natural number. In an embodiment, user network 108 is a premise network (e.g., on the premises of an organization). In another embodiment, user network 108 is a network provided by a CSP. In one scenario, there may be any number of user networks and users coupled to DaaS system 110. It is contemplated that the number of supported user networks may be in the hundreds, thousands, tens of thousands, hundreds of thousands or even millions, and the number of supported DaaS users may be tens of thousands, hundreds of thousands, millions, or even tens of millions. In practical terms, the upper limits on the number of user networks and DaaS users being supported by DaaS system 110 may be determined by the computing capacity of the cloud server and related cloud computing environment running the DaaS system. Thus, in an embodiment, the capabilities provided by DaaS system 110 may be scaled up or down to meet the requirements of very large numbers of user networks and users and may be distributed across multiple geographic sites and computing environments (e.g., areas, regions, continents, worldwide).

In an embodiment, a DaaS user may comprise any application or computing system (e.g., personal computer, laptop computer, smart phone, OT device, IT device, IoT device, etc.). During operation of DaaS system 110, one or more edge points, such as DaaS edge point 1 126, DaaS edge point 2 128, . . . . DaaS edge point K 130, where K is a natural number, may be installed and operational in user network 108. A DaaS edge point supports projecting one or more decoys into user network 108 to deceive attackers. In an embodiment, a DaaS edge point comprises an agent (e.g., implemented in either software or hardware, a hardware appliance, virtual appliance, cloud appliance, or application, etc.) running in the user network and communicating with DaaS system 110. As with the number of users, there may be any number of edge points managed by DaaS system 110, which may in some cases total millions of edge points at any given time. In an embodiment, there may be multiple DaaS systems in use.

In an embodiment, DaaS system 110 includes management console 112, deception projection and virtualization manager 114, deception services 118 and infrastructure services 136. Management console 112 provides management services to authenticate DaaS users, configure deception services 118 (e.g., decoys), and record events. Deception projection and virtualization manager 114 manages communications between DaaS edge points in user network 108 and DaaS system 110. An encrypted private tunnel (not shown in FIG. 1) is established between a DaaS edge point and DaaS system 110 for decoy session traffic transmission, which includes all outbound and inbound traffic (for example, session requests initialized by attackers), and corresponding requests sent back from deception services 118 (e.g., decoys), including edge point related traffic (for example, edge point verification, network configuration and service configuration for the projected decoy, asset discovery for the auto projection, etc.). Deception services 118 includes one or more deception services, such as DS 1 120, DS 2 122, . . . . DS L 124, where L is a natural number.

In an embodiment, a deception service may comprise a decoy, where a decoy may be represent an asset, function, service or capability in the user's network which may be attacked by an attacker. A decoy may be projected to a DaaS edge point. When an attack on a decoy projected to a DaaS edge point occurs, requests by the attacker to the projected decoy are redirected through the encrypted private tunnel to the appropriate deception service 118, handled, and one or more responses is returned to the attacker over the encrypted private tunnel. Attack event manager 116 traces attack activity, manages attack session event processing, performs attack incident aggregation, monitors attacks generally, manages attack campaign correlation, and stores information regarding the attacks for future access by users via management console 112.

Infrastructure services 136 includes monitor 138, reporter 140 and service manager 142 functions to maintain and manage the overall DaaS system 110 (e.g., monitoring of the overall server system functioning and regularly reporting of system logs, etc.)

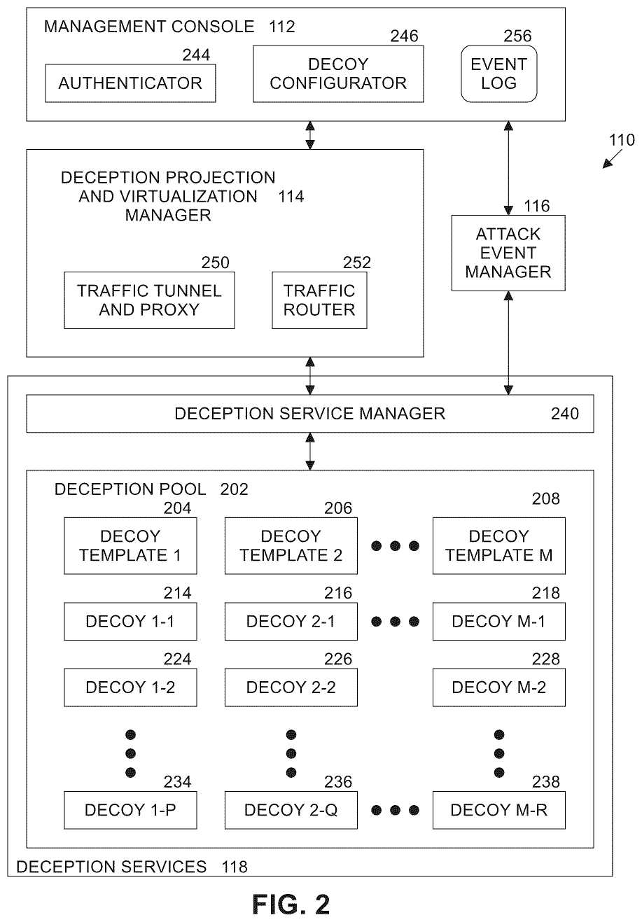

FIG. 2 illustrates DaaS system 110 architecture according to an embodiment of the present disclosure. Deception services 118 includes at least one deception pool 202. Deception pool 202 includes one or more decoy templates, such as decoy template 1 204, decoy template 2 206, . . . decoy template M 208, where M is a natural number. A decoy template may include a general description of a type of decoy. A decoy template may be customized to define one or more specific decoys. For example, decoy template 1 204 may be customized to define decoy 1-1 214, decoy 1-2 224, . . . decoy 1-P 234, where P is a natural number. Similarly, decoy template 2 206 may be customized to define decoy 2-1 216, decoy 2-2 226, . . . decoy 2-Q 234, where Q is a natural number, . . . decoy template M 208 may be customized to define decoy M-1 218, decoy M-2 228, . . . decoy M-R 234, where M and R are natural numbers. Thus, a plurality of decoys based on a plurality of decoy templates may be provided in deception pool 202. Deception service manager 240 manages access to the decoy templates and decoys in deception pool 202, including creating, updating, and deleting decoy templates and decoys, either automatically or on demand.

In an embodiment, a decoy template may define a type of decoy that may include, but is not limited to, a Linux decoy, a Windows decoy, an IoT decoy, an OT device decoy, a medical decoy, etc. Under each template category, there may be different decoy instances for each type of decoy, capable of providing different services or configurations. Additionally, different instances may be identical in terms of the configuration and template and other attributes, which are dynamically developed in the deception pool for workload sharing.

Deception projection and virtualization manager 114 includes traffic tunnel and proxy 250 and traffic router 252. Traffic tunnel and proxy 250 creates and deletes encrypted private tunnels for communication of requests and responses between a DaaS edge point and DaaS system 110. Traffic router 252 routes traffic between a DaaS edge point and a decoy.

The traffic tunnel and proxy 250 is responsible for establishing the tunnel between the edge point and the DaaS system 110 so that the communication includes the encrypted attack requests and responses, edge point system data, and configuration requests, etc. Traffic tunnel and proxy 250 also decrypts the attack requests and functions as a traffic proxy. In an embodiment, the attack request and the attack response are processed through a traffic proxy in DaaS system 110 to obfuscate identification of the decoy instance. The traffic proxy process all attack requests and re-assembles the original attack requests by replacing the original packet header information (e.g., in the original attack requests, the packet header includes the projected decoy IP address that was configured for the user defined on-premise network, projected decoy mac address customized by the user, and specified service port number of the projected decoy customized by the user) with the re-assembled packet header information (in the re-assembled packet, the header information may include the IP address of the decoy instance internally used in the DaaS system 110, the actual mac address of the selected decoy instance, and the actual service port number of the of the selected decoy instance), so that the attack request data may be successfully delivered to the selected decoy instance in the deception pool 202. The attack response, similar to the attack request, is sent out from the selected decoy instance with packet header information including the source (the selected decoy's internal use IP, mac address and port number) and destination (the proxy server's internal use IP, mac address and port number) and needs to be re-assembled by the traffic proxy server in traffic tunnel and proxy 250 to get the header information replaced. The header information for the re-assembled attack response packet includes the source (projected decoy IP address defined by the user for the on-premise network, projected decoy mac address and projected decoy port number) and destination (the original attacker's IP address, mac address and port number). The traffic tunnel and proxy 250 server sends back the attack response via the encrypted tunnel to the edge point and is delivered to the attacker. Thereafter, from the attacker's side, when the attacker receives the attack response, the attack response appears to be replied back directly from a real endpoint within the local network 108, and the attacker won't perceive that the packet is actually sent out to the DaaS system 110 and processed by the decoy running in cloud-based DaaS system.

Attack event manager 116 may store attack and response information in event log 256. Attack session tracer 116 traces and monitors all the attack session's activities occurring on all decoys in deception pool 202 and sends this information to event log 256. For example, when an attacker initializes an attack on a decoy, the attacker's identification information, such as IP address, mac address, port number, user name, login password, injected command (if applicable), accessed files, and/or injected content in the specified files, etc., will saved into the event log and subsequently displayed to the user. Event log 256 may include attack requests, response, incident reports, and related events.

In an embodiment, management console 112 includes authenticator 244, decoy configurator 246 and event log 256. Management console 112 provides a user interface platform for the user to manage, customize, and configure the projection of decoys (including example configurations such as the IP address, mac address, port number, as well as the lures, services, etc.) Management console 112 also presents the attack session log, incidents, reports, etc., to the user.

Authenticator 244 authenticates DaaS users and DaaS edge points. Once authenticated, DaaS users may log in to DaaS system 110 to view, manage and configure decoys using decoy configurator 246 (including configuring lure information) and access event log 256. Further details of the operation of DaaS system 110 are described below.

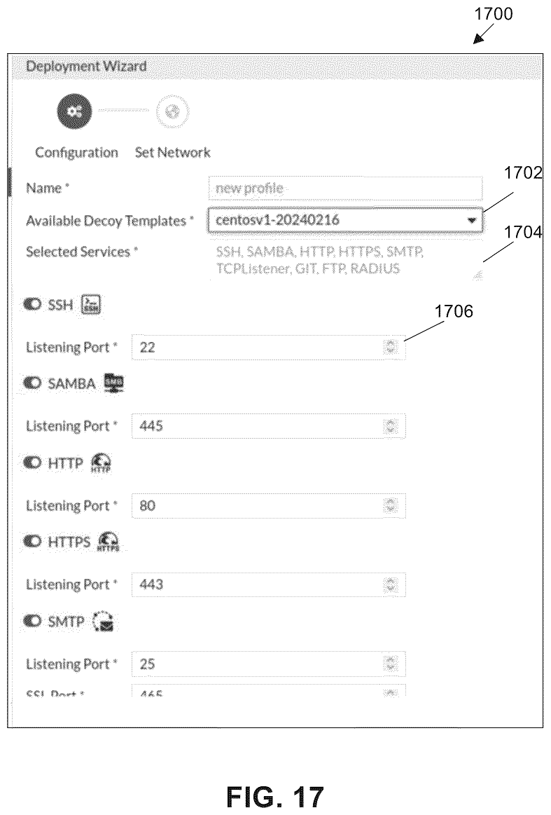

Decoy configurator 246 manages and configures decoys (including configuring lure information). Details of the decoy configurator are illustrated below in FIGS. 17, 18, and 19. Decoy configurator 246 provides the capability for the user to configure what type of decoy the user would like to project to (e.g., including but not limited to a Windows decoy, a Linux decoy, a variety of OT device decoys, a variety of IoT device decoys, a variety of medical decoy, etc.), and what services of the selected decoy the user would like to choose (e.g., including but not limited to secure shell (SSH), hyper-text transport protocol (HTTP), samba, file transfer protocol (FTP), remote desktop protocol (RDP), simple mail transfer protocol (SMTP), etc.), network setting the user would like project the decoy to the on-premise network, including configuring the IP address, mac address, and port number for the selected services, and as well as the lure information (including the user name and password for the selected services, if available). All customization and configuration selections for the user selected decoy and services may be applied to the projected decoy.

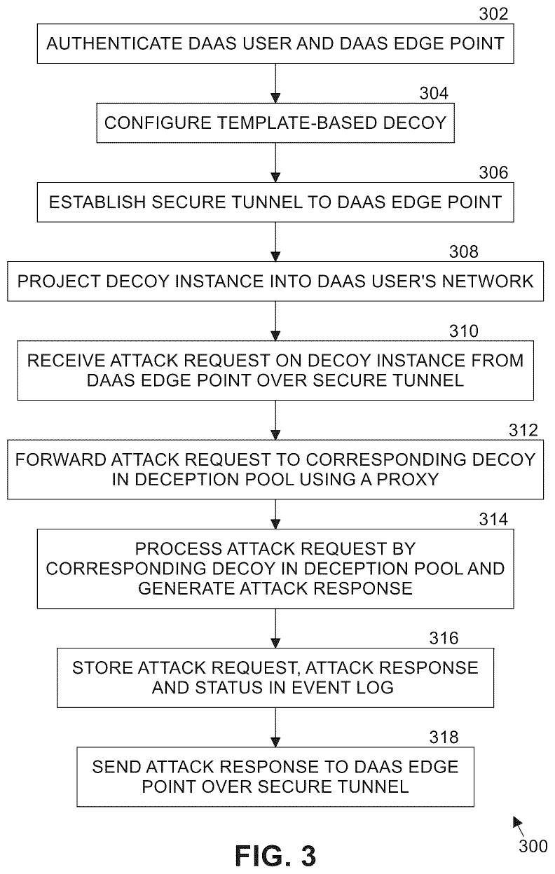

FIG. 3 illustrates DaaS system processing 300 according to an embodiment of the present disclosure. Once a DaaS edge point is installed and running in user network 108 and connected to the Internet, the user can start to authenticate and register the DaaS edge point. At block 302, authenticator 244 authenticates at least one DaaS user and at least one DaaS edge point. In an embodiment, a DaaS user may be a system administrator of an organization operating user network 108. At block 304, deception service manager 240, either automatically or on demand from a DaaS user via one or more configuration commands received via management console 112, configures a selected template-based decoy to generate a decoy instance (e.g., a clone or copy of the decoy as configured). At block 306, traffic tunnel and proxy 250 of deception projection and virtualization manager 114 establishes a secure (e.g., private encrypted) tunnel to the DaaS edge point. At block 308, deception service manager 240, via traffic tunnel and proxy 250, projects (e.g., deploys) the decoy instance into the user network of the DaaS user. In an embodiment, deployment includes initializing the decoy instance in the user network. In an embodiment, the deployed decoy instance may be associated with a selected DaaS edge point.

Once the decoy instance is running in the user network, the decoy instance may be attacked by an attacker. An attack request (e.g., any communication to the decoy instance by the attacker) may be forwarded by the DaaS edge point corresponding to the decoy instance to the associated decoy (that is, the decoy used to generate the decoy instance being attacked) in deception pool 202. At block 310, the attack request on the decoy instance may be received from the DaaS edge point over the secure tunnel by the deception service manager 240. At block 312, deception service manager 240 forwards the attack request to the decoy instance to the corresponding decoy in deception pool 202. In an embodiment, a proxy in traffic tunnel and proxy 250 may be used. At block 314, the corresponding decoy in the deception pool processes the attack request and generates an attack response. In an embodiment, the attack response may include bogus or erroneous information to confuse the attacker or defeat the intended attack. The bogus or erroneous information may be based on the attacker's request, for example, the information may include lure files and/or user lure credentials. In an embodiment, if the user attempted to use HTTP services to access the decoy, a vivid graphical user interface (GUI) interface with user data may be displayed to the attacker. All the information presented to the attacker attempts to make the decoy appear as a real service, real function, a real asset, etc., and be hard to detected as bogus by the attacker.

At block 316, the attack request, attack response, status, and optionally other information related to the attack may be stored by attack session tracer 116 in event log 256. In an embodiment, the information stored in event log 256 may include attack session tracing information, attacker identification information, an incident report, and campaign management information. Campaign management information may include a set of correlation results produced by previous incidents handled by DaaS system 110 based on the raw information of multiple incidents. In an embodiment, DaaS system 110 may implement various processes to analyze the raw elements of all detected incidents, perform correlation calculations to find out relationship among these elements, and generate the campaign results.

At block 318, DaaS system 110 sends the attack response to the DaaS edge point over the secure tunnel. In an embodiment, block 318 may be performed before or in parallel with block 316. Once stored in event log 256, attack information may be accessed by the DaaS user. DaaS system 110 may continue to monitor an attack session, recording the attacker's behavior and actions for potential future analysis by the DaaS user or others.

In an embodiment, optional third-party security services and/or automatic security policies may be employed to assist in handling attack requests. For example, if third-party security services are configured in DaaS system 110, attack requests may be blocked, and/or attackers may be quarantined based on actions triggered by a third-party security service, and/or the attack request and quarantine actions may be reported in event log 256. These actions may be performed in parallel. If no third-party security services are configured or no specific automatic security policy is applied, then the decoy sends the attack response to the DaaS edge point and the attacker receives the attack response as if the attack response came from the intended asset within the user network.

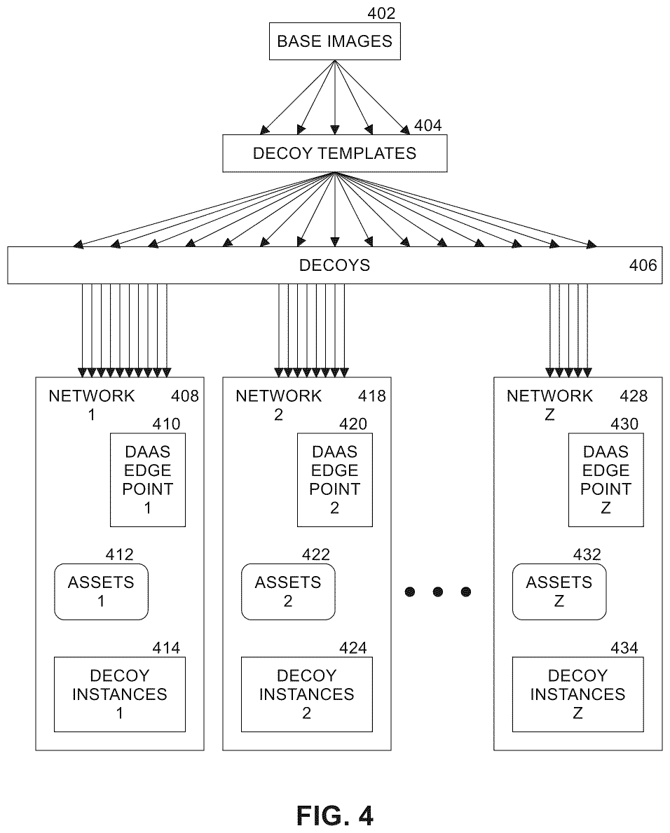

FIG. 4 illustrates deployment of template-based decoy instances according to an embodiment of the present disclosure. As disclosed herein, DaaS system 110 manages a plurality of base images 402. A base image comprises a code image of an OS or other software (e.g., application program). For example, a base image may represent one of Windows Desktop/Server, Linux®, a VPN, an OT device, an IoT device, and IT device, and so on. DaaS system 110 (via deception service manager 240 and deception pool 202) manages a plurality of decoy templates 404 based at least in part on a selected base image 402. A specific decoy template 404 may be generated based at least in part on a selected base image with selected lure data, available services, specific asset identification information, etc. Thus, a plurality of decoy templates may be generated for a given base image, as modified and/or configured. Decoy templates may be maintained and updated, which continuously adds newly discovered vulnerabilities, recent popular vulnerable device versions and models, etc., and provides a fast response for the DaaS users to apply in their networks. DaaS system 110 (via deception service manager 240 and deception pool 202) manages a plurality of decoys 406. A specific decoy 406 may be generated based at least in part on a selected decoy template 404 with specific configuration information (as shown in the example of FIG. 17). The configuration information may be provided by a DaaS user (via management console 112) to customize the decoy for the specific DaaS user and user network. In an embodiment, a decoy may be exclusively assigned to and used by a specific DaaS user. The plurality of decoys 406 may be instantiated as needed in a plurality of networks, such as network 1 408, network 2 419, . . . network Z 428, where Z is a natural number. For example, network 1 408 may include at least one DaaS edge point, such as DaaS edge point 1 410, which discovers one or more assets 1 412 on network 1 408 and deploys one or more decoy instances 1 414 (with these decoy instances being based at least in part on one or more decoys 406 as configured for network 1 408), network 2 418 may include at least one DaaS edge point, such as DaaS edge point 2 420, which discovers one or more assets 2 422 on network 2 418 and deploys one or more decoy instances 2 424 (with these decoy instances being based at least in part on one or more decoys 406 as configured for network 2 418), . . . network Z 428 may include at least one DaaS edge point, such as DaaS edge point Z 430, which discovers one or more assets Z 432 on network Z 428 and deploys one or more decoy instances Z 434 (with these decoy instances being based at least in part on one or more decoys 406 as configured for network Z 428). As used herein, an asset refers to a network device in the user on-premise network 108 with a valid IP address. An asset discovery module of DaaS system 110 may discover all user assets in the on-premise network, including but not limited to IT devices, OT devices, IoT devices, medical devices, etc.

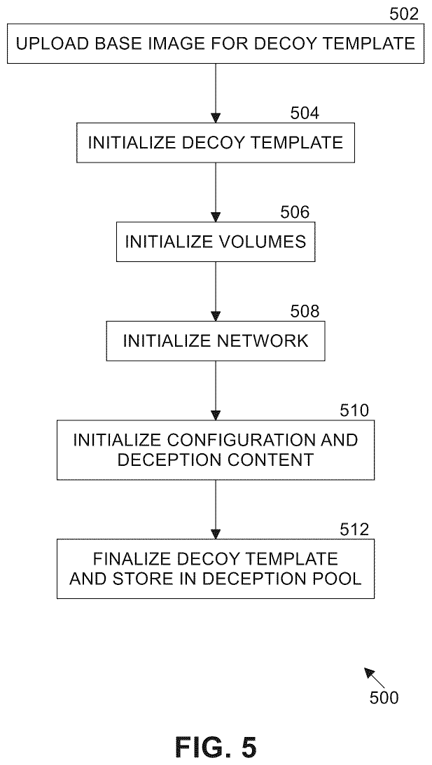

FIG. 5 illustrates initialization processing 500 for a decoy template according to an embodiment of the present disclosure. At block 502, a base image 402 may be uploaded to DaaS system 110 for a new decoy template 404. In an embodiment, this action may be performed by a system administrator of the DaaS system 110 to provide the capability to handle attacks on assets including the base image. In an embodiment, the uploading of the base image may be performed via management console 112. At block 504, deception service manager 240 (e.g., at the request of a DaaS user via management console 112), initializes a selected decoy template 404 associated with the newly uploaded base image. At block 506, deception service manager 240 initializes one or more volumes for the decoy template (where a volume is one type of storage that can be attached to decoy template dynamically, hosting the installed files and temporary changes in the template).

At block 508, deception service manager 240 initializes a network associated with the decoy template. Network initialization may include but is not limited to initializing the network interface, configuring the IP/subnet and route, configuring the network access restriction rules, setting, firewall rules, etc. At block 510, deception service manager 240 initializes configuration and deception content for the decoy template. In an embodiment, configuration for decoy template means a list of settings is configured into the deception OS for a particular template. For example, DaaS system 110 could disable the sleep/hibernate settings, modify registry entries, enable/disable Windows defender, etc., for a Windows template, or create auto launch option, disable update center, etc. for a Ubuntu template. Deception content may include a list of deception lures, which are used to lure attackers and have variety types, including but not limited to lure services, lure applications, opened ports, enabled protocols, lure credentials such as users and passwords, shared folders, honey documents, login entries, usage history records, usage activities, etc.

At block 512, deception services manager 240 finalizes the decoy template and stores the decoy template in deception pool 202. As used herein, to finalize the decoy template means the DaaS system 110 verifies the initialization status by comparing the template configuration with related items in the current template's virtual machine, sets up a corresponding recovery point and records the template information (including the updated configurations, status, resource usage information, etc.) for further usage. The new (or updated) decoy template may now be used for generating a new decoy.

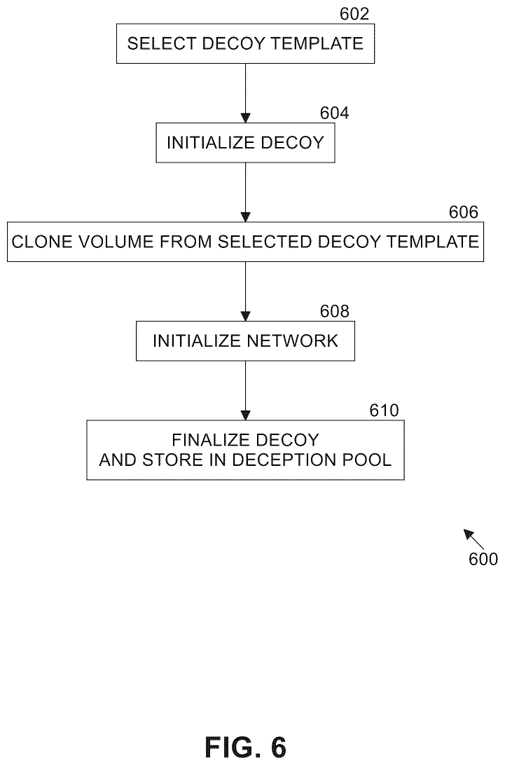

FIG. 6 illustrates initialization processing 600 for a decoy according to an embodiment of the present disclosure. This processing may be performed when a new decoy is to be created or updated from a decoy template. At block 602, deception service manager 240 selects a decoy template. In an embodiment, the selection may be indicated by a user input via management console 112. At block 604, deception service manager 240 initializes a decoy based at least in part on the selected decoy template. Initialization of a decoy describes the sub-process for initialization of a decoy including several steps, such as allocating the license and resource based on overall limitation in DaaS system 110, communicating with cloud computing platform hosting DaaS system 110 to assign corresponding storage (such as storage zone, type, encryption methods, etc.) and network resources such as IP address, subnet address, and/or mac addresses, configuring the decoy settings to the cloud computing platform with assigned resources, creating the decoy instance, and connecting the decoy instance to correct network routers.

At block 606, deception service manager 240 clones a volume from the selected decoy template. Cloning a volume may include creating a copy of storage volume based on a particular template volume; the decoy instance with cloned volume will have the same content and behaviors as the decoy template. At block 608, deception service manager 240 initializes a network associated with the decoy template. Initializing the network associated with the decoy clone may include initializing the interfaces inside the decoy, configure the IP address, subnet address, and/or mac address based at least in part on the settings from block 604, also setting up the network access restrictions, firewall rules, traffic outgoing rules, etc. At block 610, deception service manager 240 finalizes the decoy and stores the decoy in deception pool 202. Similar to finalizing the template, finalizing the decoy may include verifying that the decoy configurations, settings, and deception content, etc. are the same as expected, and recording the updated settings and status, etc., for further usage.

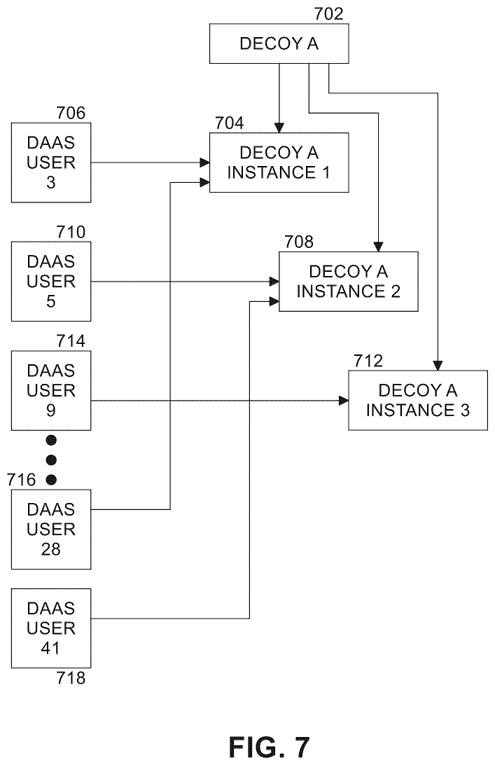

FIG. 7 illustrates an example of traffic load balancing when multiple users request access to the same decoy according to an embodiment of the present disclosure. Decoy A 702 may be used to spawn multiple decoy instances as needed. For example, decoy A 702 may be the basis for decoy A instance 1 704, decoy A instance 2 708, and decoy A instance 3 712. In an example, decoy A instance 1 704 may be experiencing a high traffic load situation with multiple requests and user connections. For example, DaaS user 3 706 and DaaS user 28 716 may be making requests to decoy A instance 1 704. To avoid increasing the latency response time and better manage load balancing, a plurality of instances of decoy A may be deployed by deception service manager 240 to accept new connections from incoming users. For example, DaaS user 5 710 and DaaS user 41 718 may be assigned to new decoy A instance 2 708 (instead of decoy A instance 1 704), and DaaS user 9 714 may be assigned to new decoy A instance 3 712 (also instead of decoy A instance 1 704). In an embodiment, the process for distributing user access to the decoy instances is aimed to balance the traffic load across multiple decoy instances, which may comprise a least connection process, a weighted response time process, a round robin process, etc.

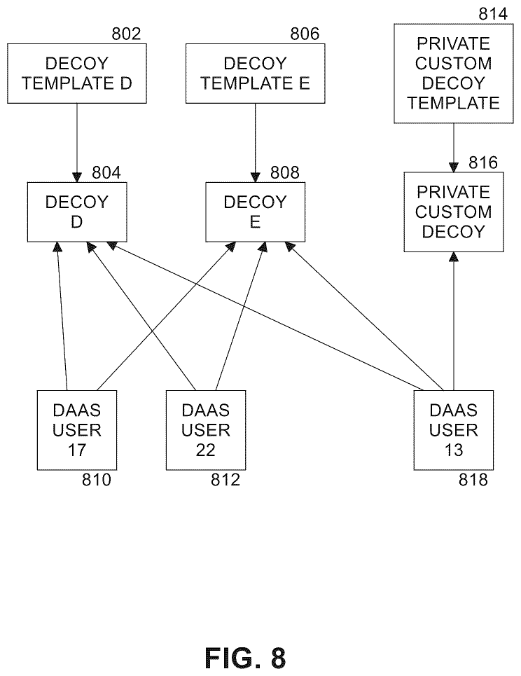

FIG. 8 illustrates an example of the use of public decoys and a private custom decoy by different users according to an embodiment of the present disclosure. A decoy template may be used to generate either a public decoy or a private custom decoy. Public decoy refers to a decoy deployed by deception service manager 240 in deception pool 202 based on existing base images 402 and decoy templates 404, and the use of the decoy is shared publicly by all subscribed users who have had the decoy instances based on the public decoy projected in their networks via a DaaS edge point. Private decoy refers to a decoy deployed by deception service manager 240 in deception pool 202 according to a specific user's customized requirements and projected as a decoy instance exclusively to that user's network with private access by that user, but not by other users. The private decoy supports customization including custom images, custom templates, custom configurations, custom services, etc. A mixture of private and public decoys in DaaS system 110 provides the capability for various decoy types, including private custom decoys which may require customization. Public decoys may be provided for popular base images/decoy templates that share access by multiple users, thereby supporting large-scale user networks (and mass virtualization) while preserving high performance for the DaaS system.

As shown in FIG. 8, a DaaS user, such as DaaS user 17 810, may have access to decoy D 804 (based on decoy template D 802) and decoy E 808 (based on decoy template E 806), and another DaaS user, such as DaaS user 22 812, may also have access to decoy D 804 and decoy E 808. However, neither DaaS user 17 810 nor DaaS user 22 812 has access to private custom decoy 816 (based on private custom decoy template 814). In contrast, DaaS user 13 818 may have access to private custom decoy 816 as well as decoy D 804 and decoy E 808.

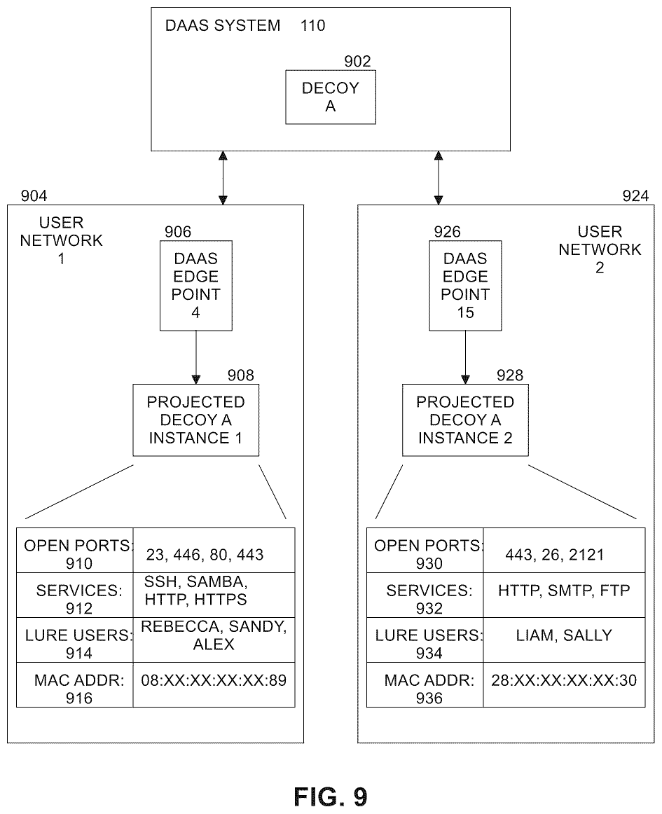

FIG. 9 illustrates an example of different projections of decoy instances based on different configurations from the same public decoy according to an embodiment of the present disclosure. In this example, decoy A 902 may be projected as two different decoy instances into user networks, shown in FIG. 9 as projected decoy A instance 1 908 in user network 1 904 and projected decoy A instance 2 928 in user network 2 924. Each projected public decoy instance may be configured with the user's IP address, MAC address, selected lure users, selected services and open ports in the user's network. For example, projected decoy A instance 1 908 has values for open ports 910, services 912, lure users 914, and MAC address (addr) 916 that may be different than the values in projected decoy A instance 2 928 for open ports 930, services 932, lure users 934, and MAC address 936. Although a specific set of configurable parameters are shown in the example of FIG. 9 for a decoy instance, in other examples other parameters may be used. Thus, a decoy instance appears as deployed locally in the user's network and behaves as a real asset, but all the traffic, sessions, requests, etc., are directed to the corresponding public decoy in deception pool 202. The public decoy (e.g., decoy A 902) supports access and connections by multiple users, as well as shares lure materials including files, services, etc., across all users of the public decoy.

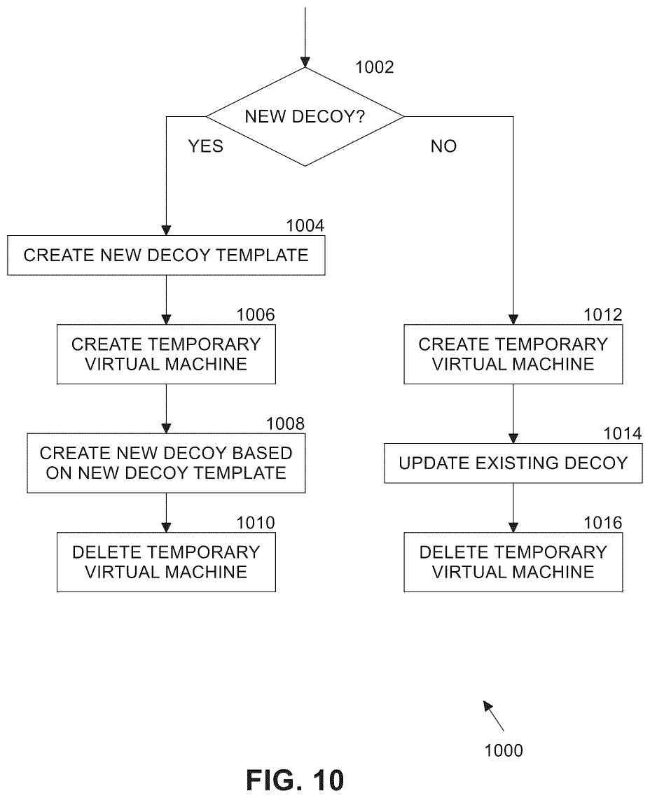

FIG. 10 illustrates processing 1000 for decoy template and decoy management according to an embodiment of the present disclosure. At block 1002, deception service manager 240 determines if an incoming request (e.g., received from a DaaS user via management console 112) is for a new decoy. If the request is for a new decoy, then at block 1004 deception service manager 240 creates a new decoy template. At block 1006, deception projection and virtualization manager 114 creates a temporary virtual machine. As on a typical cloud computing platform, all deception management operations need to be executed based on a virtual machine. Before creating a decoy based on a new decoy template, a separate step is necessary to communicate with the cloud computing platform hosting DaaS system 110 for virtual machine creation operation, including allocating VM resources, assigning storage, CPU, memory, network interfaces, and other hardware components, and initializing the VM instance.

At block 1008, deception service manager 240 creates a new decoy based at least in part on the new decoy template. The new decoy is stored in deception pool 202 and may then be used to create decoy instances. At bock 1010, deception projection and virtualization manager 114 deletes the temporary virtual machine. If the request is not for a new decoy (e.g., an existing decoy in deception pool 202), then at block 1012 deception projection and virtualization manager 114 creates a temporary virtual machine. At block 1014, deception service manager 240 updates the existing decoy. In an embodiment, updates to a decoy may be made upon discovery of new vulnerabilities, new device versions and/or models, etc. Once updated, the decoy may be used to create new decoy instances. At block 1016, deception projection and virtualization manager 114 deletes the temporary virtual machine.

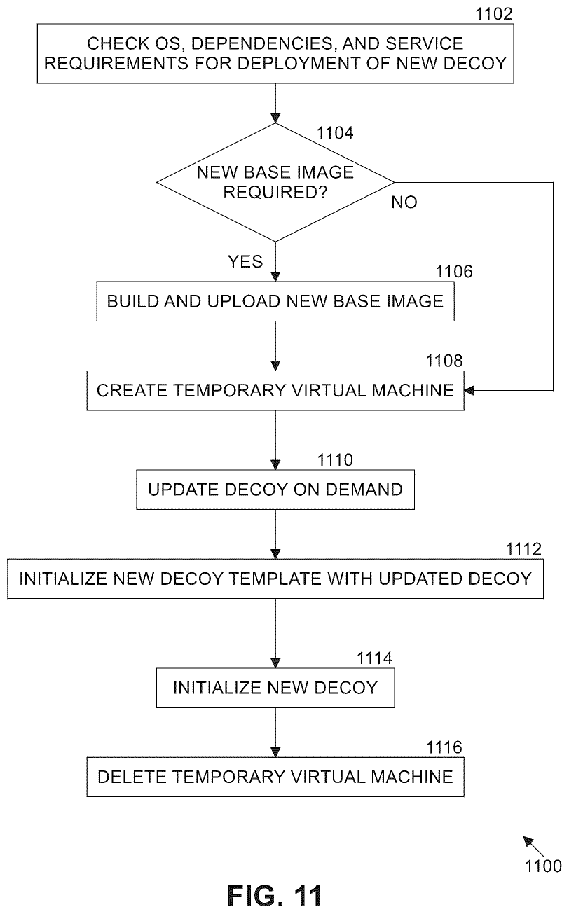

FIG. 11 illustrates processing 1100 of a new decoy template according to an embodiment of the present disclosure. At block 1102, deception service manager 240 checks for OS, dependencies, and service requirements for deployment of new decoys based at least in part on the new decoy template. At block 1104, if a new base image is required for the new decoy template, then at block 1106 a new base image is built and uploaded (e.g., via management console 112) to DaaS system 110. In an embodiment, a new base image may be built and managed by a system administrator of DaaS system 110. In either case, at block 1108, deception projection and virtualization manager 114 creates a temporary virtual machine. At block 1110, deception service manager 240 updates the decoy on demand. As used herein, on demand means process 110 may update the decoy corresponding settings based on different requirements from deployment. For example, there is a Windows 11 base image available in DaaS system 110, however a Windows 10 with a particular patch and SMBv1 is required, in such case, block 1110 will install the system patch and adjust the settings on top of the existing Windows 11 base image to prepare a new base for the new decoy template at block 1112. Thus, block 1110 may generally be used for adjusting the OS system level settings.

In an embodiment, update information may be received from a DaaS user via the management console. At block 1112, deception service manager 240 initializes the new decoy template with the updated decoy. At block 1114, deception service manager 240 initializes the new decoy. At block 1116, deception projection and virtualization manager 114 deletes the temporary virtual machine.

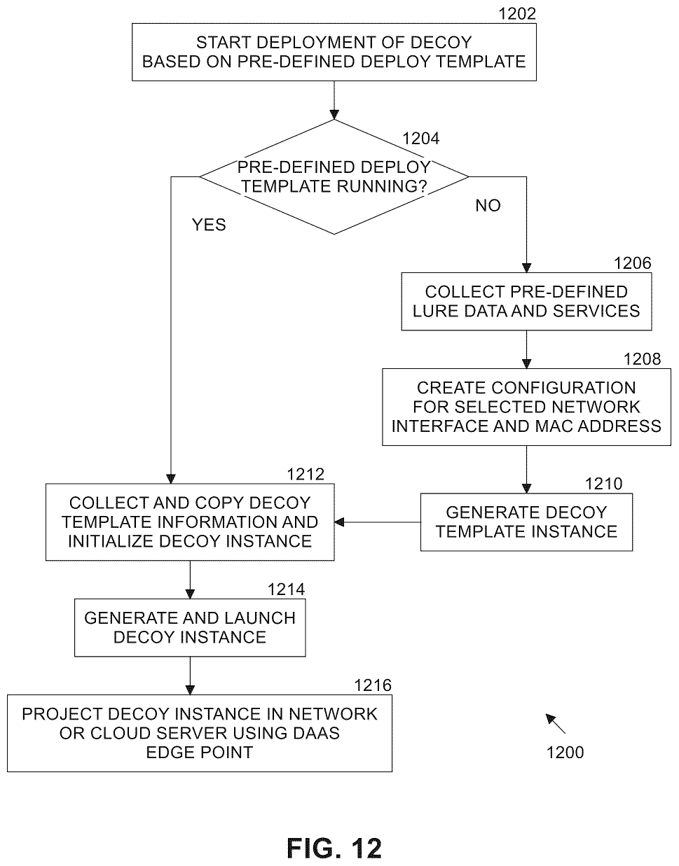

FIG. 12 illustrates processing 1200 for launching a decoy instance according to an embodiment of the present disclosure. FIG. 12 describes the process for a decoy instance based on a public decoy. For deception pool 202, deception service manager 240 may launch one or more idle template instances to handle potential requests which require customization of the configuration/settings in the decoy template to deploy as decoys. Here “running” means these idle instances. At block 1202, deception service manager 240 starts deployment of a decoy based at least in part on a pre-defined deploy template (e.g., a decoy template stored in deception pool 202). At block 1204, if the pre-defined decoy template is not running, then at block 1206 deception service manager 240 collects pre-defined lure data (e.g., lure files, lure user name and password) and services.

At block 1208, deception service manager 240 creates a configuration for a selected network interface and MAC address. At block 1210, deception service manager 240 generates a decoy template instance (e.g., a copy of a decoy template with different network information such as different network physical interfaces, IP address, MAC address, etc.). At block 1212, deception service manager 240 collects and copies decoy template information (e.g., from the decoy template instance) and initializes the decoy instance. At block 1214, decoy generator in deception service manager 240 generates and launches the decoy instance (based at least in part on the decoy template instance and the decoy template information). At block 1216, deception projection and virtualization manager 114 projects (e.g., deploys) the decoy instance in a network (e.g., network 108) or a cloud server using a DaaS edge point.

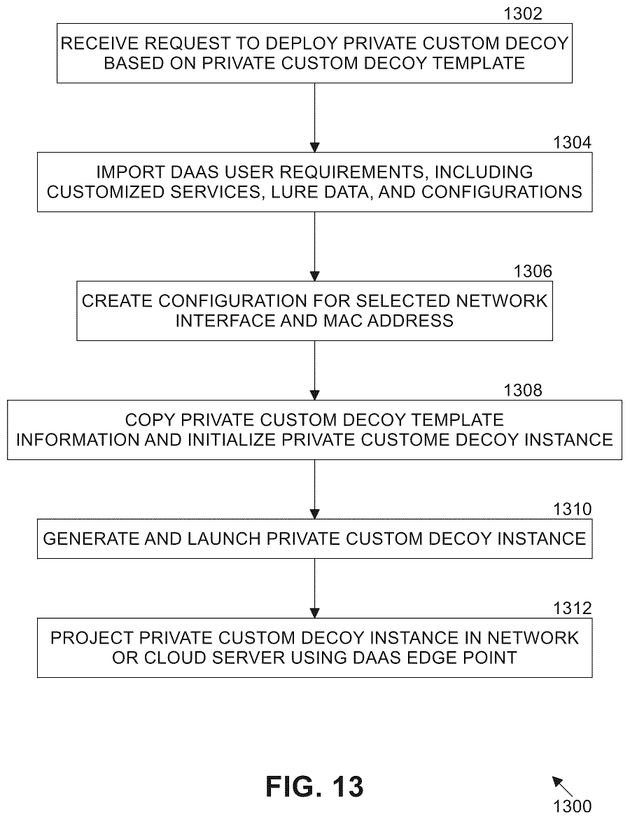

FIG. 13 illustrates processing 1300 for launching a private custom decoy instance according to an embodiment of the present disclosure. At block 1302, DaaS system 110 receives a request (e.g., via management console 112) to deploy a private custom decoy based at least in part on a private custom decoy template. At block 1304, deception service manager 240 imports DaaS user requirements, including customized services, lure data, and configurations. In an embodiment, this information may be included in the request. At block 1306, deception service manager 240 creates a configuration for a selected network interface and MAC address. At block 1308, deception service manager 240 copies private custom decoy template information and initializes the private custom decoy instance. At block 1310, decoy generator in deception service manager 240 generates and launches the private custom decoy instance (based at least in part on the private custom decoy and the private custom decoy template information). At block 1312, deception projection and virtualization manager 114 projects (e.g., deploys) the private custom decoy instance in a network (e.g., network 108) or a cloud server using a DaaS edge point.

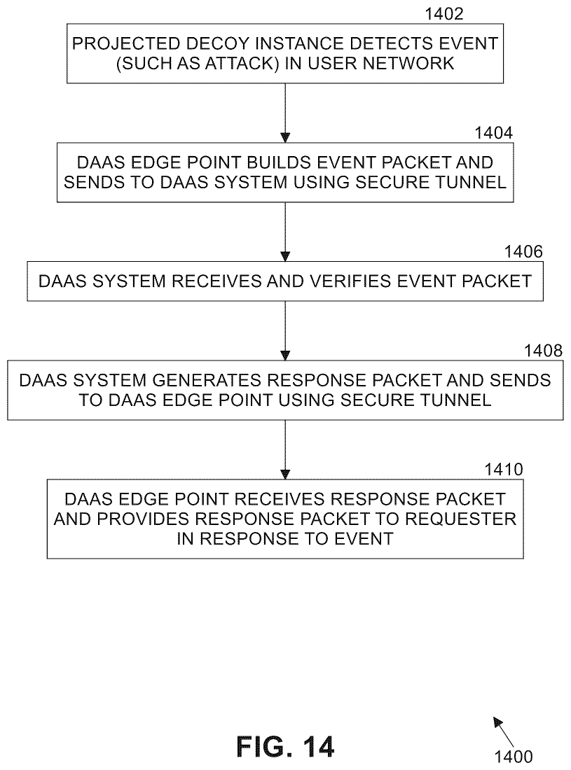

FIG. 14 illustrates processing 1400 and communications between DaaS system 110 and DaaS edge point according to an embodiment of the present disclosure. At block 1402, a projected decoy instance may detect an event (such as an attack request by an attacker) in the DaaS user's network. At block 1404, DaaS edge point builds an event packet (including an attack request from the detected event) and sends the event packet to Daas system 110 using a secure tunnel (e.g., as set up by traffic tunnel and proxy 250 of deception projection and virtualization manager 114). At block 1406, DaaS system 110 receives the event packet and verifies the event packet as authentic. At block 1408, DaaS system 110 generates a response packet (e.g., by routing the attack request to the decoy in deception pool 202 corresponding to the decoy instance detecting the event) and sends the response packet to the DaaS edge point using the secure tunnel. At block 1410, the DaaS edge point receives the response packet and provides the response packet (or optionally, a portion thereof) to the requester in response to the detected event (e.g., provides a spoofed response to the attacker instead of a legitimate response).

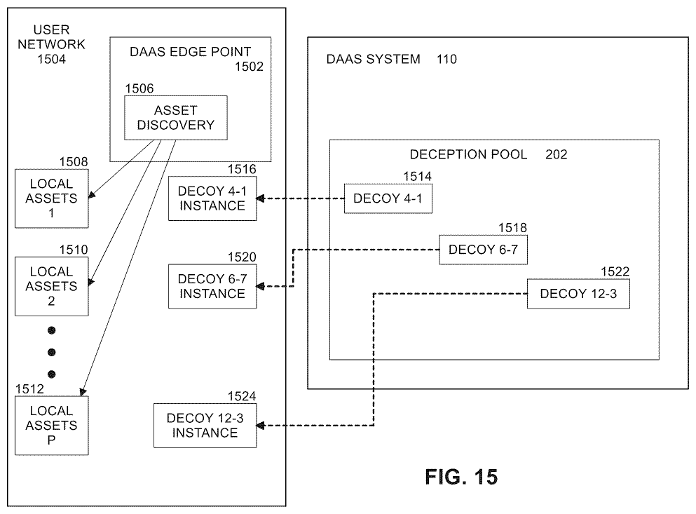

FIG. 15 illustrates an example of asset discovery and deployment of decoy instances according to an embodiment of the present disclosure. FIG. 15 shows an example of a workflow in which DaaS system 110 manages the traffic proxy and user data tracing for mass virtualized decoy instances across different users with multiple decoy projections. The DaaS user that initializes the decoy setup process with asset discovery may be either from the user network 1504 or remote. The user authentication process is handled by management console 112 of DaaS system 110, which also provides incident and attack events data. Once authenticated, the DaaS user sends the setup request with configuration settings to the management console. The request is delivered from the cloud through the secure traffic tunnel to DaaS edge point 1502 that has been already installed in the user network 1504, where the user's assets are located. In this example, assets may include local device 1 1508, local device 2 1510, . . . local device P 1512, where P is a natural number. In an embodiment, DaaS edge point 1502 includes asset discovery node 1506 to perform the asset discovery in either active or passive traffic monitoring modes to collect local device identification information of the assets (e.g., local device 1 1508, local device 2 1510, . . . local device P 1512) in user network 1504. The asset discovery result may be sent by DaaS edge point 1502 back via the secure traffic tunnel and processed by DaaS system 110 in a cloud server to optimize the recommended decoys with specific configurations tailored according to the assets and network environment at the user end. Then, the selected optimized decoys may be selected, configured and projected into user network 1504. For example, decoy 4-1 1514 of deception pool 202 may be selected and configured to correspond to discovered local device 1 1508 and decoy 4-1 instance 1516 may be projected to user network 1504, decoy 6-7 1518 may be selected and configured to correspond to discovered local device 2 1510 and decoy 6-7 instance 1520 may be projected to the user network, . . . decoy 12-3 1522 may be selected and configured to correspond to discovered local device P 1512 and decoy 12-3 instance 1524 may be projected to the user network. The decoy instances projected to the user network is a projection with a valid IP address, mac address, and port number that can received attack requests, so the decoy will appear as a “real” service provided by a “real” local network device in the network (but they are projected from the Daas system 110 via the DaaS edge point). The DaaS edge point may be a physical or virtual appliance or a software application that runs as a tunnel agent and connected with the DaaS system 110.

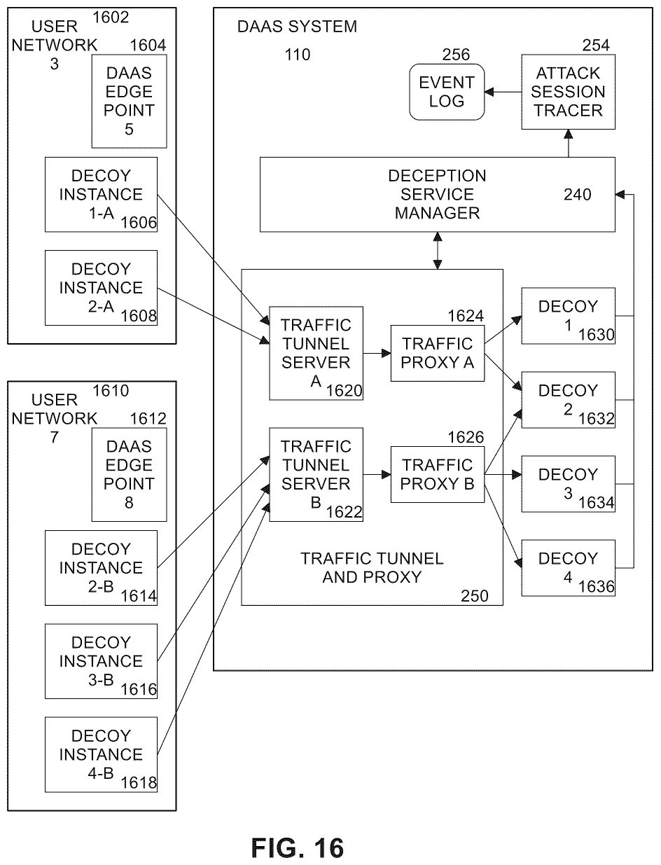

FIG. 16 illustrates an example of traffic management for multiple deployed decoy instances and user networks according to an example of the present disclosure. In this example, two decoy instances named decoy instance 1-A 1606 and decoy instance 2-A 1608 are projected into user network 3 1602 including DaaS edge point 5 1604, these decoy instances being based on decoy 1 1630 and decoy 2 1632, respectively, in DaaS system 110. Similarly, three decoy instances named decoy instance 2-B 1614, decoy instance 3-B 1616, and decoy instance 4-B 1618 are projected into user network 7 1610 including DaaS edge point 8 1612, these decoy instances being based on decoy 2 1632, decoy 3 1634, and decoy 4 1636, respectively. The traffic from the decoy instances for each user network may be processed through different assigned traffic tunnels and virtual network switches. For example, traffic from decoy instance 1-A 1606 and decoy instance 2-A 1608 may be processed by traffic tunnel server A 1620 and traffic proxy 1624 of traffic tunnel and proxy 250, and traffic from decoy instance 2-B 1614, decoy instance 3-B 1616, and decoy instance 4-B 1618 may be processed by traffic tunnel server B 1622 and traffic proxy 1626 as shown. If an attack session occurs, the attack session data (e.g., including an attack request and response) and incident log may be processed and/or stored by attack session tracer 254 via deception service manager 210. The incident log and attack reports may be saved to a database, called event log 256 herein, which the DaaS user may access from the user's premise network (e.g., user network 3 1602 or user network 7 1610, in this example) and remotely via a user portal running in management console 112 of DaaS system 110.

FIG. 17 illustrates an example of a user interface 1700 for a deployment wizard to configure a decoy according to an example of the present disclosure. In this example, a list of available decoy templates may be shown in a drop-down menu 1702. A list of available services to select for the decoy may be shown in box 1704, and a port configuration 1706 for the decoy may also be shown. The user selections may be used to define how to project the decoy instance based on the decoy to the user's network.

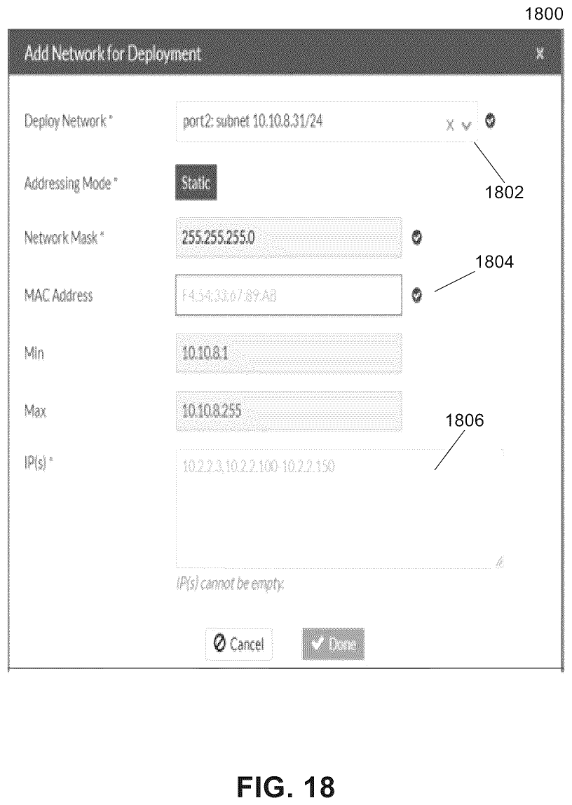

FIG. 18 illustrates an example of a user interface 1800 to select a network for deployment of a decoy according to an example of the present disclosure. The user may define the IP address and MAC address for the projection of a decoy instance into the user's network. In this example, a user network selection 1802 (as sensed by a DaaS edge point) may be shown. A MAC address 1804 and an IP address 1806 may also be selected.

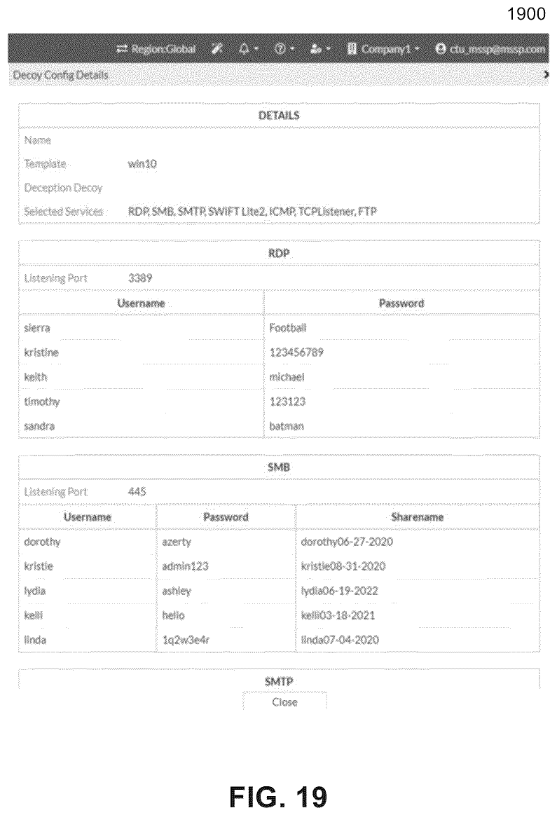

FIG. 19 illustrates an example of user interface 1900 to display a summary of the decoy configuration according to an example of the present disclosure. In this example, the summary page displays the configuration and lure details projected to the user's network by the DaaS user via the management console 112.

While in the context of the example described with reference to the flow diagrams of this disclosure, a number of enumerated blocks are included, it is to be understood that examples may include additional blocks before, after, and/or in between the enumerated blocks. Similarly, in some examples, one or more of the enumerated blocks may be omitted and/or performed in a different order.

Embodiments of the present disclosure include various steps, which have been described above. The steps may be performed by hardware components or may be embodied in machine-executable instructions, which may be used to cause one or more processing resources (e.g., one or more general-purpose and/or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a tangible non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or general-purpose computer hardware to execute the code contained therein. An apparatus for practicing various embodiments of the present disclosure may involve one or more computer systems (e.g., physical and/or virtual servers, physical and/or virtual network security appliances) (or one or more processors within a single computer system) and storage systems containing or having network access to computer program(s) coded in accordance with various methods described herein, and the method steps associated with embodiments of the present disclosure may be accomplished by modules, routines, subroutines, or subparts of a computer program product.

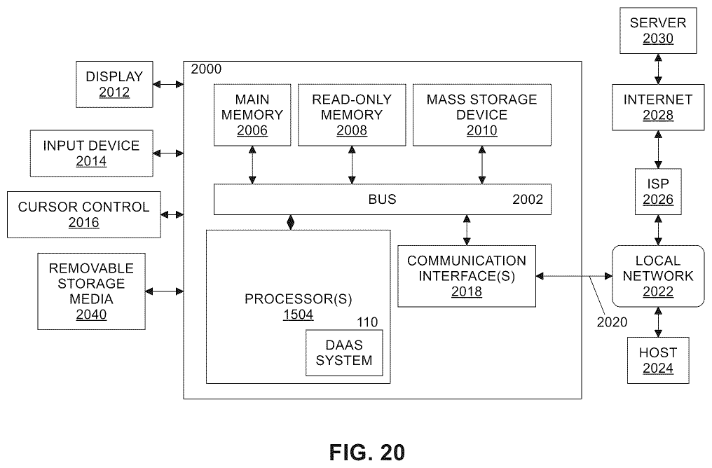

FIG. 20 illustrates an example computing system in which or with which embodiments of the present disclosure may be utilized. FIG. 20 shows a block diagram that illustrates a computing system 2000 in which or with which an embodiment of the present disclosure may be implemented. Computing system 2000 may be representative of a computer server (e.g., a cloud server in a cloud computing environment) on which a DaaS system 110 is running. Notably, components of computing system 2000 described herein are meant only to exemplify various possibilities. In no way should the example computing system 2000 limit the scope of the present disclosure. In the context of the present example, computing system 2000 includes a bus 2002 or other communication mechanism for communicating information, and one or more processing resources (e.g., one or more hardware processors 2004) coupled with bus 2002 for processing information. Hardware processors 2004 may include, for example, one or more general purpose microprocessors available from one or more current or future microprocessor manufactures (e.g., Intel Corporation, Advanced Micro Devices, Inc., and/or the like) and/or one or more special purpose processors (e.g., graphics processing units (GPUs), network processors (NPs), and/or accelerators or co-processors). In some examples, one or more processing resources may be part of an application specific integrated circuit (ASIC)-based security processing unit (e.g., the FORTISP family of security processing units available from Fortinet, Inc. of Sunnyvale, CA).

Computing system 2000 also includes a main memory 2006, such as a machine-readable random-access memory (RAM) or other dynamic storage device, coupled to bus 2002 for storing information and instructions (e.g., DaaS system 110) to be executed by processor(s) 2004. Main memory 2006 also may be used for storing temporary variables or other intermediate information during execution of instructions to be executed by processor(s) 2004. Such instructions, when stored in non-transitory storage media accessible to processor(s) 2004, render computing system 2000 into a special-purpose machine that is customized to perform the operations specified in the instructions.

Computing system 2000 further includes a read only memory (ROM) 2008 or other static storage device coupled to bus 2002 for storing static information and instructions (e.g., DaaS system 110) for processor(s) 2004. A storage device 2010, e.g., a magnetic disk, optical disk or flash disk (made of flash memory chips), is provided and coupled to bus 2002 for storing information and instructions.

Computing system 2000 may be coupled via bus 2002 to a display 2012, e.g., a cathode ray tube (CRT), Liquid Crystal Display (LCD), Organic Light-Emitting Diode Display (OLED), Digital Light Processing Display (DLP) or the like, for displaying information to a computer user. An input device 2014, including alphanumeric and other keys, is coupled to bus 2002 for communicating information and command selections to processor(s) 2004. Another type of user input device is cursor control 2016, such as a mouse, a trackball, a trackpad, or cursor direction keys for communicating direction information and command selections to processor(s) 2004 and for controlling cursor movement on display 2012. The input device typically has two degrees of freedom in two axes, a first axis (e.g., x) and a second axis (e.g., y), that allows the device to specify positions in a plane.

Removable storage media 2040 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computing system 2000 may implement the techniques described herein using customized hard-wired logic, one or more ASICs or field programmable gate arrays (FPGAs), firmware or program logic which in combination with the computer system causes or programs computing system 2000 to be a special-purpose machine. According to one embodiment, the techniques herein are performed by computing system 2000 in response to processor(s) 2004 executing one or more sequences of one or more instructions (e.g., DaaS system 110) contained in main memory 2006. Such instructions may be read into main memory 2006 from another storage medium, such as storage device 2010. Execution of the sequences of instructions contained in main memory 2006 causes processor(s) 2004 to perform the process steps described herein. In alternative embodiments, hard-wired circuitry may be used in place of or in combination with software instructions.

The term “storage media” as used herein refers to any non-transitory machine-readable media that store data or instructions that cause a machine to operate in a specific fashion. Such storage media may comprise non-volatile media or volatile media. Non-volatile media includes, for example, optical, magnetic or flash disks, such as storage device 2010. Volatile media includes dynamic memory, such as main memory 2006. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 2002. Transmission media can also take the form of acoustic or light waves, such as those generated during radio-wave and infra-red data communications.

Various forms of media may be involved in carrying one or more sequences of one or more instructions to processor(s) 2004 for execution. For example, the instructions may initially be carried on a magnetic disk or solid-state drive of a remote computer. The remote computer can load the instructions into its dynamic memory and send the instructions over a telephone line using a modem. A modem local to computer system 2000 can receive the data on the telephone line and use an infra-red transmitter to convert the data to an infra-red signal. An infra-red detector can receive the data carried in the infra-red signal and appropriate circuitry can place the data on bus 2002. Bus 2002 carries the data to main memory 2006, from which processor(s) 2004 retrieve and execute the instructions. The instructions received by main memory 2006 may optionally be stored on storage device 2010 either before or after execution by processor(s) 2004.

Computing system 2000 also includes a communication interface 2018 coupled to bus 2002. Communication interface 2018 provides a two-way data communication coupling to a network link 2020 that is connected to a local network 2022. For example, communication interface 2018 may be an integrated services digital network (ISDN) card, cable modem, satellite modem, or a modem to provide a data communication connection to a corresponding type of telephone line. As another example, communication interface 2018 may be a local area network (LAN) card to provide a data communication connection to a compatible LAN. Wireless links may also be implemented. In any such implementation, communication interface 2018 sends and receives electrical, electromagnetic or optical signals that carry digital data streams representing various types of information.

Network link 2020 typically provides data communication through one or more networks to other data devices. For example, network link 2020 may provide a connection through local network 2022 to a host computer 2024 or to data equipment operated by an Internet Service Provider (ISP) 2026. ISP 2026 in turn provides data communication services through the world-wide packet data communication network now commonly referred to as the “Internet” 2028. Local network 2022 and Internet 2028 both use electrical, electromagnetic or optical signals that carry digital data streams. The signals through the various networks and the signals on network link 2020 and through communication interface 2018, which carry the digital data to and from computing system 2000, are example forms of transmission media.

Computing system 2000 can send messages and receive data, including program code, through the network(s), network link 2020 and communication interface 2018. In the Internet example, a server 2030 might transmit a requested code for an application program through Internet 2028, ISP 2026, local network 2022 and communication interface 2018. The received code may be executed by processor(s) 2004 as it is received, or stored in storage device 2010, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
configuring, by a deception system executing in a computing system, a decoy to generate a decoy instance;
projecting the decoy instance into a user network coupled to the computing system;
receiving, by the decoy in the deception system, from an edge point in the user network, an attack request on the decoy instance by an attacker;
generating an attack response by the decoy based at least in part on the attack request; and
sending the attack response to the attacker.

2. The method of claim 1, wherein the attack response comprises erroneous information.

3. The method of claim 2, wherein the erroneous information comprises at least one of a lure file and lure credentials.

4. The method of claim 1, comprising installing, by the deception system, the edge point in the user network.

5. The method of claim 4, comprising authenticating, by the deception system, a user of the user network and the edge point.

6. The method of claim 1, wherein the decoy is based on a decoy template in the deception system.

7. The method of claim 6, wherein the decoy template comprises a description of a type of decoy, and further comprising customizing the decoy template to define the decoy.

8. The method of claim 6, wherein the decoy template is based on a base image, the base image comprising a code image of at least one of an operating system software or an application program.

9. The method of claim 6, wherein the decoy template comprises a private custom decoy template exclusive to the user network and the decoy comprises a private custom deploy based on the private custom decoy template.

10. The method of claim 6, wherein the decoy template comprises a public decoy template for use in a plurality of user networks.

11. The method of claim 1, comprising establishing a private encrypted tunnel between the edge point in the user network and the decoy in the deception system.

12. The method of claim 1, wherein the decoy comprises at least one asset, function, service or capability in the user network.

13. The method of claim 1, wherein the decoy may comprise one of a Linux decoy, a Windows decoy, and an Internet of Things (IoT) decoy.

14. The method of claim 1, comprising communicating the attack request and the attack response through a traffic proxy in the deception system to obfuscate identification of the decoy instance.

15. A non-transitory, machine-readable medium storing instructions, which when executed by one or more processing resources, cause the one or more processing resources to:
configure a decoy to generate a decoy instance;
project the decoy instance into a user network;
receive, from an edge point in the user network, an attack request on the decoy instance by an attacker;
generate an attack response by the decoy based at least in part on the attack request; and
send the attack response to the attacker.

16. The non-transitory, machine-readable medium of claim 15, wherein the decoy is based on a decoy template.

17. The non-transitory, machine-readable medium of claim 16, wherein the decoy template comprises a description of a type of decoy, and further comprising instructions to cause the one or more processing resources to customize the decoy template to define the decoy.

18. An apparatus comprising:
processing circuitry; and
instructions that when executed by the processing circuitry cause the apparatus to:
configure a decoy to generate a decoy instance;
project the decoy instance into a user network;
receive, from an edge point in the user network, an attack request on the decoy instance by an attacker;
generate an attack response by the decoy based at least in part on the attack request; and
send the attack response to the attacker.

19. The apparatus of claim 18, wherein the attack response comprises erroneous information.

20. The apparatus of claim 18, wherein the decoy comprises at least one asset, function, service or capability in the user network.
